(19) United States
(12) Patent Application Publication
(10) Pub. No.: US 2021/0187802 A1
(43) Pub. Date: Jun. 24, 2021

(54) DEVICE AND METHOD FOR PRODUCING PLASTICS COMPONENTS

(71) Applicant: FTE automotive GmbH, Ebern (DE)

(72) Inventors: Sebastian NEUBAUER, Ebern (DE); Thomas POHL, Ebern (DE)

(73) Assignee: FTE automotive GmbH, Ebern (DE)

(21) Appl. No.: 17/123,399

(22) Filed: Dec. 16, 2020

(30) Foreign Application Priority Data
Dec. 20, 2019 (DE) 10 2019 135 640.7

(51) Int. Cl. B29C 45/00; B29C 45/27

(52) U.S. Cl. CPC B29C 45/0025; F16D 25/12; B29C 45/2703

(57) ABSTRACT

A device that produces component from a plastics material by injection moulding includes two mould halves. The two mould halves can be pressed together releasably and, in the pressed-together state, form at least one gate region and at least one common cavity for moulding the plastics material. The gate region is fluidically connected to the cavity for the purpose of introducing the plastics material into the cavity. At least one deflecting element is provided, which is arranged movably in the gate region and is formed to prevent or at least to impede flowing of the plastics material through a partial region of the gate region, the location of which results from the respective position of the deflecting element, in a manner depending on the respective position of the deflecting element

The present invention relates to a device, in particular an injection-moulding tool, for producing a component from a plastics material by means of injection moulding in accordance with the preamble of claim 1. The invention furthermore relates to a method for producing a component by means of injection moulding in accordance with the preamble of claim 14. In particular, the invention relates to a device and a method for producing cylinder housings, in particular cylinder housings for concentric slave cylinders.

Hydraulic clutch actuating means for motor vehicles comprise a master cylinder, which can be actuated for example via a clutch pedal, and a slave cylinder, which is hydraulically connected to the master cylinder via a pressure line. The pressure created in the master cylinder by actuating the clutch pedal is transmitted via the pressure line to the slave cylinder by a pressure medium, with the result that the slave cylinder applies the actuating force to the release bearing of the friction clutch in order to separate the motor from the transmission of the motor vehicle via a release mechanism. In this respect, the slave cylinder can be in the form of an annular cylinder which is arranged around the clutch and/or transmission shaft and, for example, is fastened to the transmission housing. Such slave cylinders are also referred to as central release mechanisms or central actuators on account of their concentric arrangement with respect to the shaft.

Central release mechanisms and/or central actuators frequently have a cylinder housing which is manufactured from plastic and has at least one external cylinder wall. This cylinder wall radially outwardly delimits an annular pressure chamber in which the annular piston, which is operatively connected to the clutch, is displaceably accommodated. The cylinder housing furthermore has a pressure connector which opens out in the pressure chamber and via which the pressure medium can be admitted to the pressure chamber in order to release the clutch.

Cylinder housings of this type are usually produced in large numbers by means of injection moulding. In the process, a suitable plastic is melted in an injection unit of an injection-moulding machine and injected into the cavity of an injection-moulding tool, in which cavity the plastic resolidifies, before the injection-moulded part is removed from the mould after opening of the injection-moulding tool. The molten plastic passes out of the injection unit through a nozzle into a gate region of the injection-moulding tool and is pressed out of this region into the cavity. The cavity, i.e. the hollow space, of the injection-moulding tool determines the form and the surface structure of the finished component. In turn, the form of the gate region that is to be selected results from the form of the component to be produced.

For rotationally symmetrically formed components, such as for example cylinder housings, e.g. fan-shaped gate regions are provided, through which the plastics material can flow into the cavity uniformly over the entire periphery of said cavity. Even if the plastic distributes uniformly in the cavity when a fan gate is used, a weld line still forms in the region in which the plastics compound last converges (i.e. the flow fronts meet). This effect can in particular arise whenever supports or other part geometries directly adjoin the cylinder housing. This has the result that the finished component is slightly weakened in the region of the weld line, and therefore in this region the risk of leakages occurring is increased. At which point and/or in which region of the finished component the weld line occurs depends in particular on the form and surface structure of the cavity and previously was scarcely able to be influenced, at least if it is not possible or desired to change the form and structure of the component. This is disadvantageous in particular whenever the weld line is in a region of the finished component which cannot readily be strengthened, for example by increasing the wall thickness, in order to compensate the weakening owing to the weld line.

The present invention is based on the object of providing a device and a method of the type mentioned at the beginning which make it possible to increase the stability of finished, in particular cylindrical injection-moulded components having a weld line, without changing the form and surface structure of the cavity of the injection-moulding tool.

Said object is achieved according to the invention by a device according to claim 1. Advantageous configurations and expedient developments of the invention become apparent from dependent claims 2 to 8.

The device according to the invention is distinguished advantageously in that at least one deflecting element (“insert”) is provided, which is arranged movably in the gate region, wherein the deflecting element is formed to prevent or at least to impede and/or to delay flowing of the plastics material through a partial region of the gate region, the location of which results from the respective position of the deflecting element, in a manner depending on the respective position of said deflecting element. Since the deflecting element can be moved in the gate region, the flow of the plastics material into the cavity can be influenced in an active and dynamic manner. Moving the deflecting element during the injecting operation brings about the effect that the portions of the gate region that cannot be flowed through by the plastics material on account of the deflecting element are dynamically displaced. That respective region of the cavity of the injection-moulding tool which, depending on the respective position of the deflecting element, lies downstream of the gate region and thus is filled last or at least in a delayed manner with the plastics material (i.e. in which the flow fronts of the plastics compound meet and form the weld line) is consequently displaced in the course of the injecting operation, which in turn influences the form and/or the progression of the weld line. Furthermore, the dynamic displacement of the weld line makes it possible to avoid the disadvantage that, in the case of cylindrical components, the plastic fibres in the region of a conventional linear weld line align along the longitudinal axis of the component and thereby bring about additional weakening of the mechanical load-bearing capacity of the component. As a result of avoiding a linear weld line that runs along the longitudinal axis of the component, for example by creating a curved or spiral-shaped weld line in a targeted manner, it is advantageously achieved that the plastic fibres along the weld line align obliquely or perpendicularly with respect to the longitudinal axis of the component and thus the mechanical stability of the entire component, in particular with respect to forces acting perpendicular to the longitudinal axis of the component, is significantly increased. By moving the deflecting element within the gate region, the form of the weld line in finished, for example cylindrical injection-moulded components can thus be changed without having to change the form and surface structure of the cavity of the injection-moulding tool. This has the advantage that the weld line can be formed in a targeted manner in such a way that it is possible to at least compensate the weakening of the finished component by the weld line. Overall, the device according to the invention thus allows the production of a component by means of injection moulding that has increased stability and/or in which the location of the regions with increased stability can be set in a targeted manner.

In a particularly advantageous configuration of the invention, the deflecting element is fastened to a shaft. In this way, the deflecting element can be moved on a circular path within the gate region, and therefore it can assume virtually all positions within the gate region. The form of the weld line of the finished component can thereby be influenced for example in such a way that it runs in a curved and/or spiral-shaped manner. In addition, in the context of the technical options, the deflecting element can be rotated at any desired predefined speed, with the result that, for example, in the case of a fan-shaped gate region the pitch of the spiral-shaped weld line can be set in a targeted manner. The shaft can be moved actively or can also rotate passively due to the movement of the plastics compound.

The deflecting element can in this case be fastened releasably or non-releasably to the shaft. A releasable fastening is advantageous in particular whenever a variable insertion of differently formed and/or dimensioned deflecting elements is necessary to vary forms of the weld line in a quick and simple manner. A non-releasable fastening of the deflecting element on the shaft can be advantageous in particular when a stable injection-moulding tool with a low susceptibility to faults is required for series production.

The deflecting element can have different forms and/or outer contours. According to the invention, the deflecting element merely has to ensure that undisrupted flowing of the plastics material through the gate region is prevented or impeded. In principle, it is thus sufficient that the deflecting element is configured in such a way that, in that portion of the gate region at which the plastics material enters same, it constitutes an obstacle which prevents or impedes the entry of the plastics material. In this portion of the gate region, said deflecting element can thus for example have a wall-like or screen-like structure, while the remaining constituent parts of the deflecting element serve to fix it, for example to a shaft.

The deflecting element can, for example, be formed in the shape of a quarter of a circle, a semicircle or three-quarters of a circle. When a circular and/or fan-shaped gate region is used, the deflecting element can thus cover for example 25%, 50% or 75% (90°, 180° or 270° of 360°) of the gate region.

According to a particularly advantageous embodiment of the device according to the invention, the form of the deflecting element is adapted to the form of the gate region and at least partially fills the gate region. The deflecting element is thus preferably formed in such a way that it completely fills at least a certain portion of the gate region and thus blocks the passage of the plastics material through this portion. For example, the deflecting element can at least partially be a solid element which can be inserted in a form-fitting manner into the gate region or a portion of the gate region. The deflecting element can, however, for example also be an at least partially hollow element, the surface of which is adapted to the form of the gate region and thus can be inserted in a form-fitting manner into the gate region or a portion of the gate region.

Advantageously, the deflecting element can be fastened releasably to the shaft, for example by at least one fastening means. This fastening means is preferably adapted to corresponding structures of the shaft. For example, the deflecting element can comprise the at least one fastening means, in this case the fastening means being fastened in a separable manner to the shaft. As an alternative or in addition, however, the shaft can also comprise the at least one fastening means, in this embodiment the deflecting element being fastened in a separable manner to the fastening means. The fastening means could also be a separate element which, at one end, has a configuration corresponding to a structure of the shaft in the form of an adapter and, at its opposite end, has a configuration corresponding to a structure of the deflecting element.

The device according to the invention can advantageously be used whenever the gate region is formed in the shape of a fan (fan gate), disc and/or plate (disc gate, ring gate) or film (film gate).

It is favourable when the movement of the deflecting element is brought about solely by the inflowing plastics melt during the injection-moulding operation. For this purpose, the deflecting element can advantageously have at least one suitably formed deflecting face, which comes into contact with the inflowing plastics material and thereby brings about a movement of the deflecting element.

As an alternative or in addition, the deflecting element can, however, also be moved independently of the inflowing plastics melt. For this purpose, for example, an electric motor or a hydraulic motor operated in particular via hydraulic connectors of the device can be provided. Furthermore, tool slides of the device can also be used to move the deflecting element.

It is particularly advantageous when, at the cavity, at the gate region, at the deflecting element or at an element of the device that is connected to the deflecting element, such as for instance a shaft, the device has at least one sensor, in particular a pressure sensor, by means of which a parameter of the injection-moulding process, in particular the internal pressure of the mould that prevails in the cavity, can be detected in order to be able to control the movement of the deflecting element depending on the parameter data detected. For this purpose, the signals sent by the at least one sensor are advantageously supplied to a control unit of the device that correspondingly actuates the drive means for the purpose of moving the deflecting element. In particular, the measuring signals from a plurality of sensors, which are arranged at a variety of points on the device, can also be supplied to the control unit for this purpose.

The device according to the invention is advantageously provided and/or particularly suitable for use in the production of cylinder housings, in particular cylinder housings for concentric slave cylinders (central release mechanisms and/or central actuators).

The object is achieved according to the invention also by a deflecting element according to claim 12. Advantageous configurations and expedient developments of the invention become apparent from dependent claims 13 to 16.

The deflecting element according to the invention is provided for at least partial insertion into a gate region of an injection moulding tool and is distinguished advantageously in that it is movable and formed to prevent or at least to impede flowing of the plastics material through a partial region of the gate region, the location of which results from the respective position of the deflecting element. Since the deflecting element is of a movable form, the flow of the plastics material into the cavity of the injection-moulding tool can be influenced in an active and dynamic manner. Moving the deflecting element during the injecting operation brings about the effect that the portions of the gate region that cannot be flowed through by the plastics material on account of the deflecting element are dynamically displaced. That respective region of the cavity of the injection-moulding tool which, depending on the respective position of the deflecting element, lies downstream of the gate region and thus is filled last or at least in a delayed manner with the plastics material (i.e. in which the flow fronts of the plastics compound meet and form the weld line) is consequently displaced in the course of the injecting operation, which in turn influences the form and/or the progression of the weld line. This has the advantage that the weld line can be formed in a targeted manner in such a way that it is possible to at least compensate the weakening of the finished component by the weld line. Overall, the device according to the invention thus allows the production of a component by means of injection moulding that has increased stability and/or in which the location of the regions with increased stability can be set in a targeted manner.

In a particularly advantageous configuration of the invention, the deflecting element is fastened releasably or non-releasably to a shaft. In this way, the deflecting element can be moved on a circular path within the gate region, and therefore it can assume virtually all positions within the gate region. In addition, in the context of the technical options, the deflecting element can be rotated at any desired predefined speed, with the result that, for example, in the case of a fan-shaped gate region the pitch of the spiral-shaped weld line can be set in a targeted manner.

The deflecting element can, for example, be formed in the shape of a quarter of a circle, a semicircle or three-quarters of a circle. When a circular and/or fan-shaped gate region is used, the deflecting element can thus cover for example 25%, 50% or 75% (90°, 180° or 270° of 360°) of the gate region. If the deflecting element is inserted into a fan gate of an injection-moulding tool, it can advantageously extend over a sector of the fan-shaped gate region that covers preferably an angle of between 60° and 300°, in particular an angle of between 80° and 200°, 80° and 100° or 170° and 200°, and particularly preferably an angle of between 90° and 180° and/or 180° and 270°.

According to a particularly advantageous embodiment of the deflecting element according to the invention, its form is adapted to the form of the gate region. The deflecting element can thus have different forms and/or outer contours depending on the form of the gate region. According to the invention, it merely has to be ensured that the deflecting element partially prevents or impedes flowing of the plastics material through the gate region. In an advantageous configuration of the invention, the deflecting element can be configured for example in such a way that, in that portion of the gate region at which the plastics material enters the gate region and/or the cavity, said deflecting element constitutes an obstacle which prevents or impedes the entry of the plastics material. In this portion of the gate region, said deflecting element can for example have a wall-like or screen-like structure, while the remaining constituent parts of the deflecting element serve to fix it, for example to a shaft. The deflecting element can also be formed in such a way that it completely fills at least a certain portion of the gate region and thus blocks the passage of the plastics material through this portion. For example, the deflecting element can at least partially be a solid element which can be inserted in a form-fitting manner into the gate region or a portion of the gate region. The deflecting element can, however, for example also be an at least partially hollow element, the surface of which is adapted to the form of the gate region and thus can be inserted in a form-fitting manner into the gate region or a portion of the gate region.

In an advantageous configuration of the invention, the deflecting element can for example comprise at least one fastening means. This fastening means is preferably adapted to corresponding structures, for example a shaft, and serves to fix the deflecting element to the shaft.

According to the invention, the object is also achieved by a method for producing a component by means of injection moulding according to claim 17. Advantageous configurations and expedient developments of the invention become apparent from dependent claims 18 to 20.

The method, in which two mould halves are pressed together releasably, wherein, in the pressed-together state, the two mould halves form at least one gate region and at least one common cavity for moulding the plastics material, and in which a plastics material is melted and/or liquefied by heating and subsequently introduced into the cavity via the gate region, is characterized according to the invention in that at least one deflecting element (“insert”) is moved in the gate region during the introduction of the plastics material into the cavity, wherein the deflecting element prevents or at least impedes and/or delays flowing of the plastics material through a partial region of the gate region, the location of which results from the respective position of the deflecting element, in a manner depending on the respective position of said deflecting element. Since the deflecting element is moved in the gate region, the flow of the plastics material into the cavity can be influenced in an active and dynamic manner. Moving the deflecting element during the injecting operation brings about the effect that the portions of the gate region that cannot be flowed through by the plastics material on account of the deflecting element are dynamically displaced. That respective region of the cavity of the injection-moulding tool which, depending on the respective position of the deflecting element, lies downstream of the gate region and thus is filled last or at least in a delayed manner with the plastics material (i.e. in which the flow fronts of the plastics compound meet and form the weld line) is consequently displaced in the course of the injecting operation, which in turn influences the form and/or the progression of the weld line. Furthermore, the dynamic displacement of the weld line makes it possible to avoid the disadvantage that, in the case of cylindrical components, the plastic fibres in the region of a conventional linear weld line align along the longitudinal axis of the component and thereby bring about additional weakening of the mechanical load-bearing capacity of the component. As a result of avoiding a linear weld line that runs along the longitudinal axis of the component, for example by creating a curved or spiral-shaped weld line in a targeted manner, it is advantageously achieved that the plastic fibres along the weld line align obliquely or perpendicularly with respect to the longitudinal axis of the component and thus the mechanical stability of the entire component, in particular with respect to forces acting perpendicular to the longitudinal axis of the component, is significantly increased. By moving the deflecting element within the gate region, the form of the weld line in finished, for example cylindrical injection-moulded components can thus be changed without having to change the form and surface structure of the cavity of the injection-moulding tool. This has the advantage that the weld line can be formed in a targeted manner in such a way that it is possible to at least compensate the weakening of the finished component by the weld line. Overall, the method according to the invention thus allows the production of a component by means of injection moulding that has increased stability and/or in which the location of the regions with increased stability can be set in a targeted manner.

In an advantageous configuration of the method according to the invention, the deflecting element is moved on a circular path in the gate region, preferably by means of a shaft. In this way, the deflecting element can assume virtually all positions within the gate region. In addition, in the context of the technical options, the deflecting element can be rotated at any desired predefined speed, with the result that, for example, in the case of a fan-shaped gate region the pitch of the spiral-shaped weld line can be set in a targeted manner. The deflecting element passes through the circular path preferably at least once during the introduction of the plastics material, with the result that, in the case of a fan-shaped gate region, the weld line runs over the entire periphery of the cylindrical component. The curvature of the weld line depends here on the speed at which the deflecting element is moved, i.e. the angle which is enclosed by the weld line and the longitudinal axis of the component and/or cylinder becomes larger with increasing rotational speed. In other words, the faster the deflecting element rotates in the gate region, the more obliquely the weld line runs; and the more oblique the weld line, the more stable is the component produced in this way. In addition, a high rotational speed by virtue of the creation of turbulences in the plastics compound brings about a better mixing of said plastics compound and thus a more homogeneous component.

In a particularly advantageous configuration of the method according to the invention, the speed at which the deflecting element is moved thus depends on the duration of the introduction of the plastics material, i.e. the shorter the injection duration, the faster the deflecting element has to be moved in the gate region. When a thermoplastic material is used, if an injecting operation lasts for 2 seconds for example, the deflecting element should thus completely pass through the gate region within this time period at least once, so that the weld line runs uniformly in the finished product.

The method according to the invention is suitable in particular for processing thermoplastic materials and thermosetting plastics.

The invention relates advantageously for example to a cylinder housing, in particular a cylinder housing for a concentric central actuator for a hydraulic or pneumatic clutch actuating means, which has been produced by a method according to claims 17 to 20 and/or by means of a device according to one of claims 1 to 11.

The invention described is not limited only to a concentric slave cylinder but can be applied to any type of plastic component in a vehicle transmission, such as hydraulic component, master cylinder, actuator, parking lock device, pump or electric pump, gear-shifter, valves, throttle, etc.

Further advantages and features of the invention become apparent from the following description with regard to the exemplary embodiments illustrated in the drawings, in which:

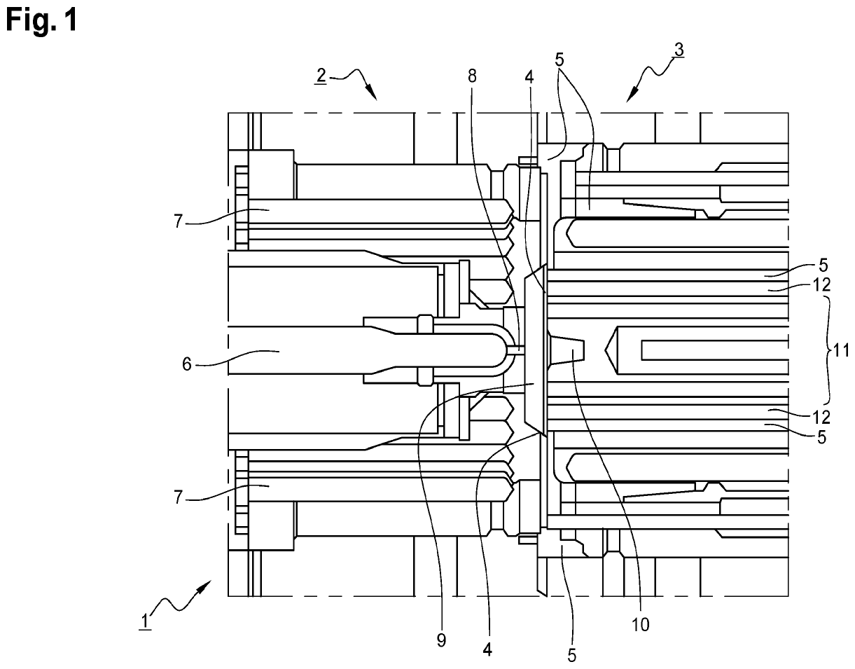

FIG. 1: shows a longitudinal section through a part of an exemplary embodiment of a device according to the invention,

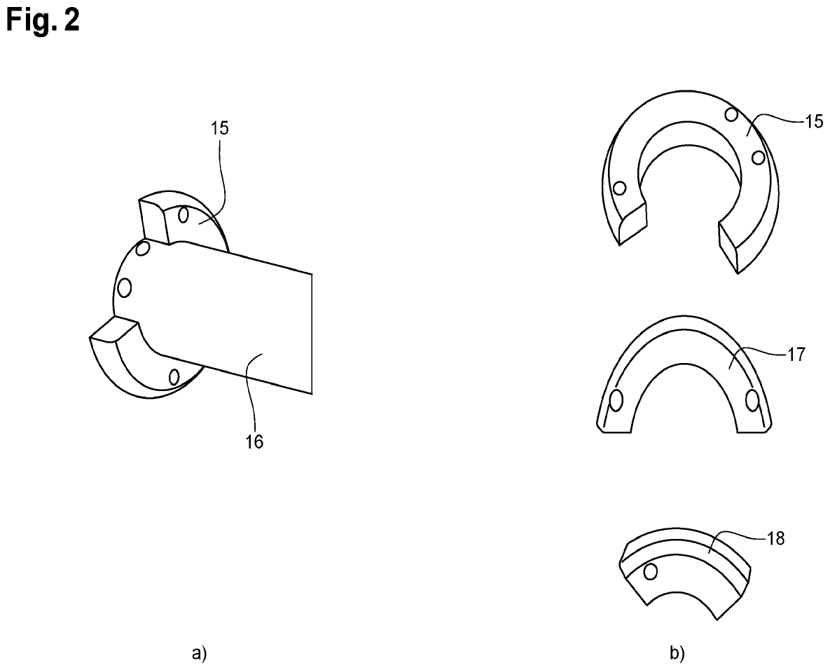

FIG. 2: a) shows a perspective view of a deflecting element according to the invention which is fastened to a shaft,

b) shows a perspective view of different exemplary embodiments of the deflecting element according to the invention,

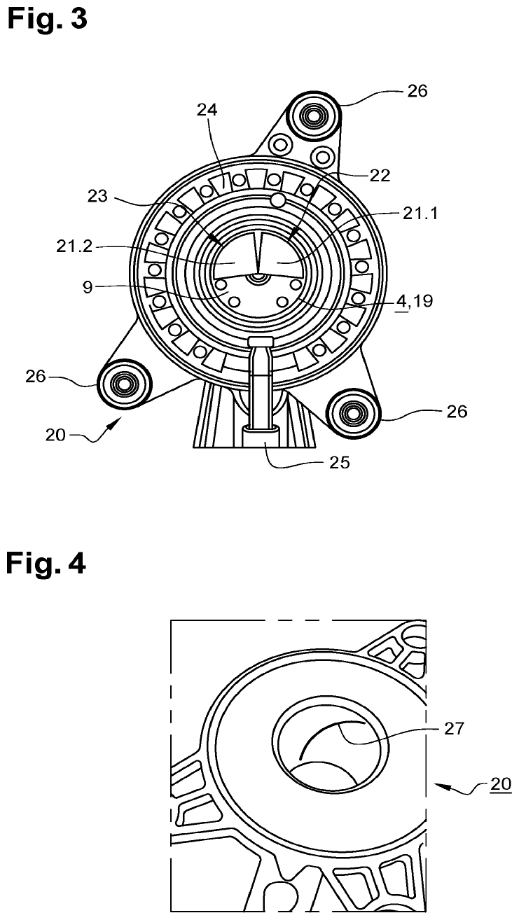

FIG. 3: shows a plan view of the “ejector side” of a finished component with a schematic illustration of different positions of the deflecting element according to the invention, and

FIG. 4: shows a perspective view of a finished component with a weld line.

For the purpose of simplification, identical elements are denoted by identical reference signs in the figures even in the case of different embodiments.

FIG. 1 shows a longitudinal section through a part of an exemplary embodiment of a device 1 for producing a plastics component by means of injection moulding. The device 1, which can be in particular a part of an injection-moulding tool, comprises a first mould half 2 (“nozzle side”, illustrated only partially here) and a second mould half 3 (“ejector side”, likewise illustrated only partially here) which form the injection-moulding tool for moulding the plastics material. The two mould halves 2, 3 can be brought into contact by axially displacing one of the two mould halves 2, 3 or both mould halves 2, 3, the injection-moulding tool being closed by pressing together the two mould halves 2, 3. In the closed state, illustrated here, the two pressed-together mould halves 2, 3 enclose a gate region 4 and a common cavity 5, in which the component to be produced is formed. In the embodiment illustrated here, the gate system comprises an injection channel 6 for injecting the plastics material into the cavity 5, which is configured as a hot-runner variant. The injection unit of the injection-moulding machine presses a molten, fluid plastics material into the injection channel 6, which can be heated by a temperature controlling device 7 for controlling the temperature of the plastics material located in the injection channel 6. The fluid plastics material is injected out of the injection channel 6 into the gate region 4 via a nozzle 8, there firstly strikes a plate- and/or fan-shaped element 9 and then flows over said element into the cavity 5. On the “nozzle side”, the fan-shaped element 9 forms an injection face and thus in practical terms constitutes a fan gate. On the “ejector side”, the fan-shaped element 9 comprises a central extension 10 which can be pushed in a form-fitting manner into a corresponding depression in the second mould half 3. The second mould half 3 comprises a central cylinder 11 (see FIG. 2) which is surrounded by a free space 12. The second mould half 3 also has an ejector device (the ejectors of the ejector device are not visible here, since they are shortened in this embodiment), by means of which the moulded and hardened finished component can be ejected out of the injection-moulding tool at the end of the injection-moulding operation.

FIG. 2 a) shows a perspective view of an exemplary deflecting element 15 according to the invention, which is fastened to a shaft 16. The deflecting element 15 is formed in the shape of three-quarters of a circle and can thus cover 75% (270° of 360°) of a circular portion, for example of a fan-shaped gate region.

FIG. 2 b) shows the deflecting element 15 according to the invention without a shaft (at the top) and two further exemplary embodiments of the deflecting element 17, 18 according to the invention. The deflecting element 17 (in the middle) is formed in the shape of a semicircle, while the deflecting element 18 (at the bottom) is formed in the shape of a quarter of a circle. The deflecting element 17 can thus cover 50% (180° of 360°) and the deflecting element 18 can thus cover 25% (90° of 360°) of a circular portion, for example of a fan-shaped gate region.

FIG. 3 shows that side (“ejector side”) of a finished component 20 which faces the second mould half 3 according to FIG. 1, the fan-shaped element 9, which forms the fan gate, and, schematically, different positions of a deflecting element 21 according to the invention additionally also being reproduced in this illustration. The embodiment illustrated here is a test variant, in which, after ejecting the component 20 out of the injection-moulding tool, the fan-shaped element 9 remains initially in the component 20, and therefore said test variant still has to be removed therefrom for further use. The deflecting element 21 is positioned within the gate region 4 of the device 1 according to FIG. 1 initially in such a way that it prevents flowing of the molten plastics material into a first region of the cavity 5, which is located downstream of the first portion 22 of the gate region 4 that is covered by the deflecting element 21 (position 21.1). The deflecting element 21 is then rotated counterclockwise within the gate region 4 of the device 1 according to FIG. 1 in such a way that it prevents flowing of the molten plastics material into a second region of the cavity 5, which is located downstream of the second portion 23 of the gate region 4 that is covered by the deflecting element 21 (position 21.2). Since the deflecting element 21, on account of its different positions in a sequence offset in time, blocks and/or delays flowing of the plastics material into different regions of the circular portion 19 of the gate region 4, the form and/or the progression of the weld line which forms in the region in which the flow fronts of the plastics material meet can be changed in a targeted manner by moving the deflecting element 21 in the gate region. Thus, for example, during the production of cylindrical components, a curved weld line can be created by rotating the deflecting element in the fan gate (see FIG. 4).

The component 20 is a cylinder housing for a concentric central actuator (central release mechanism). The component 20 comprises an annular base body 24, onto which are moulded a pressure connector 25 and three flanges 26, which are provided to fasten the cylinder housing to for example a transmission housing of a motor vehicle. The pressure connector 25 is formed by means of a mould core which is placed into the injection-moulding tool and around which the plastic flows during the injection-moulding operation. The pressure connector 25 is fluidically connected to the annular working space of the cylinder formed by the base body 20, and therefore a pressure medium can be admitted to the cylinder.

FIG. 4 shows that side (“nozzle side”) of a finished component 20 which faces the first mould half 2 according to FIG. 1, which component has been produced by the method according to the invention and by means of a device according to the invention having a movable deflecting element. The weld line 27 is no longer a straight line which extends along the longitudinal axis of the cylindrical component 20, but rather runs in a curved manner, since the deflecting element has been moved within the gate region during the injecting operation. FIG. 3 thus shows that the form and/or the progression of the weld line in the finished injection-moulded components can be influenced in a targeted manner by moving a deflecting element within the gate region, without the form and surface structure of the cavity of the injection-moulding tool having to be changed. For example, a curved or spiral-shaped weld line can be created by means of the method according to the invention. In this way, the mechanical strength of injection-moulded components can be significantly increased.

### LIST OF REFERENCE SIGNS

1 Device
2 Mould half
3 Mould half
4 Gate region
5 Cavity
6 Injection channel
7 Temperature controlling device
8 Nozzle
9 Fan-shaped element
10 Extension
11 Central cylinder
12 Free space
13
14
15 Deflecting element
16 Shaft
17 Deflecting element
18 Deflecting element
19 Circular portion
20 Component
21 Deflecting element
22 First portion
23 Second portion
24 Base body
25 Pressure connector
26 Flange
27 Weld line

1-21. (canceled)

22. A device for producing a component from a plastics material by injection moulding, the device comprising:
two mould halves configured to be pressed together releasably and, in the pressed-together state, form at least one gate region and at least one common cavity for moulding the plastics material, wherein the gate region is fluidically connected to the cavity to introduce the plastics material into said cavity,
wherein at least one deflecting element is arranged movably in the gate region,
wherein the deflecting element is formed to prevent or at least to impede flowing of the plastics material through a partial region of the gate region, the location of which results from the respective position (of the deflecting element, in a manner depending on the respective position of said deflecting element.

23. The device according to claim 22, wherein the deflecting element is fastened to a shaft.

24. The device according to claim 22, wherein the deflecting element is formed in the shape of a quarter of a circle, a semicircle, or three-quarters of a circle.

25. The device according to claim 22, wherein the form of the deflecting element is adapted to the form of the gate region and at least partially fills said gate region.

26. The device according to claim 23, wherein the deflecting element is fastened releasably to the shaft by at least one fastening means.

27. The device according to claim 26, wherein the deflecting element comprises the at least one fastening means, or the shaft comprises the at least one fastening means and the deflecting element is fastened to the fastening means.

28. The device according to claim 22, wherein the gate region is formed in the shape of a fan, disc and/or plate, or film.

29. The device according to claim 22, wherein the deflecting element has at least one deflecting face, which brings about a movement of the deflecting element by contact with the inflowing plastics material.

30. The device according to claim 22, wherein the deflecting element is configured to be moved by at least one tool slide of the device or by a hydraulic motor or by an electric motor.

31. The device according to claim 22, wherein at least one sensor is arranged at the cavity, at the gate region, at the deflecting element, or at an element of the device that is connected to the deflecting element, the sensor is configured to detect a parameter of the injection-moulding process, and the sensor is configured to provide control signals for controlling the movement of the deflecting element depending on the parameter data detected.

32. The device according to claim 22, wherein the device is configured to be used in the production of cylinder housings.

33. A deflecting element for at least partial insertion into a gate region of an injection-moulding tool, wherein the deflecting element is movable and is formed to prevent or at least to impede flowing of the plastics material through a partial region of the gate region, the location of which results from the respective position of the deflecting element.

34. The deflecting element according to claim 33, wherein the deflecting element is fastened to a shaft.

35. The deflecting element according to claim 33, wherein the deflecting element is formed in the shape of a quarter of a circle, a semicircle, or three-quarters of a circle.

36. The deflecting element according to claim 33, wherein a form of the deflecting element is adapted to the form of the gate region.

37. The deflecting element according to claim 33, further comprising at least one fastening means.

38. A method for producing a component by injection moulding, comprising:
pressing two mould halves together releasably, wherein, in the pressed-together state, the two mould halves form at least one gate region and at least one common cavity for moulding the plastics material;
liquefying a plastics material by heating and subsequently introducing the plastics material into the cavity via the gate region,
wherein, during the introduction of the plastics material into the cavity, at least one deflecting element is moved in the gate region,
wherein the deflecting element prevents or at least impedes flowing of the plastics material through a partial region of the gate region, the location of which results from the respective position of the deflecting element, in a manner depending on the respective position of said deflecting element.

39. The method according to claim 38, wherein the deflecting element is moved on a circular path in the gate region.

40. The method according to claim 39, wherein the deflecting element passes through the circular path at least once during the introduction of the plastics material.

41. The method according to claim 38, wherein the speed at which the deflecting element is moved depends on the duration of the introduction of the plastics material.

42. A cylinder housing that is produced by the method according to claim 38.
